(19) United States
(12) Patent Application Publication
(10) Pub. No.: US 2015/0286998 A1
(43) Pub. Date: Oct. 8, 2015

(54) Methods and Systems for Facilitating Transactions

(71) Applicant: MASTERCARD INTERNATIONAL INCORPORATED, Purchase, NY (US)

(72) Inventor: Martin Thackray, Cambridgeshire (GB)

(21) Appl. No.: 14/679,069

(22) Filed: Apr. 6, 2015

(30) Foreign Application Priority Data
Apr. 7, 2014 (GB) 1406223.6

(51) Int. Cl. G06Q 20/10

(52) U.S. Cl. CPC G06Q 20/10

(57) ABSTRACT

There is provided an apparatus and method of processing a transaction, the method being performed at a network node and comprising operating a processor to: receive, in a first account, funds from a plurality of accounts, the received funds being associated with a first session identifier; store a first information set in association with the first session identifier, the first information set comprising details of the funds received; transfer, from the first account, a payment amount to a third party account, the transfer being associated with the first session identifier; update the first information set in accordance with the transferred payment amount; determine, based on the first information set, that the first account comprises remaining funds associated with the first session identifier; and transfer a respective portion of the remaining funds to each of the plurality of accounts.

### FIELD

The present disclosure relates to methods and systems for facilitating transactions between multiple user devices. More particularly, it relates to methods and systems for facilitating multiple user devices to communicate over a network to complete transactions.

### BACKGROUND

This section provides background information related to the present disclosure which is not necessarily prior art.

There are many scenarios in which it is desirable to affect a single transaction on behalf of multiple participants. For example, a group of people may wish to participate in an event or purchase goods or services on behalf of the group. In such scenarios, processing an individual transaction between a third party supplier and each of the group participants is highly inefficient. This is because the number of transactions involved, and the resulting processing, increases as the number of participants increases. Additionally, the amount to be paid by each of the group members varies as the group membership increases or decreases making it difficult for accurate payments to be made.

Furthermore, third party suppliers receiving payment via such a plurality of transactions are at risk as full payment is only guaranteed on completion of the processing in respect of the final transaction in the group. Hence, it is desirable to provide a method of facilitating multiple users to communicate to complete a specified transaction with a third party.

### SUMMARY

This section provides a general summary of the disclosure, and is not a comprehensive disclosure of its full scope or all of its features.

According to an aspect of the disclosure, there is provided a computer-implemented method of processing a transaction, the method being performed at a network node and comprising operating a processor to: receive, in a first account, funds from a plurality of accounts, the received funds being associated with a first session identifier; store a first information set in association with the first session identifier, the first information set comprising details of the funds received; transfer, from the first account, a payment amount to a third party account, the transfer being associated with the first session identifier; update the first information set in accordance with the transferred payment amount; determine, based on the first information set, that the first account comprises remaining funds associated with the first session identifier; and transfer a respective portion of the remaining funds to each of the plurality of accounts.

In some embodiments, prior to receiving funds from a plurality of accounts, the method comprises operating the processor to: transmit an invite to a respective device associated with each of the plurality of accounts, the invite comprising an indication of the first session identifier. The invite may further comprise an indication of an amount of funds to be transferred to the first account.

In some embodiments, the first information set comprises data indicative of a respective amount received from each of the plurality of accounts and the processor is operated to determine a portion of the remaining funds to transfer to each of the plurality of accounts in accordance with the amount received from the respective account.

The processor may be further operated to: receive, in the first account, funds from a second plurality of accounts, the received funds being associated with a second session identifier; store a second information set in association with the second session identifier, the second information set comprising details of the funds received from the second plurality of accounts; transfer, from the first account, a payment amount to a third party account, the transfer being associated with the second session identifier; update the second information set in accordance with the transferred payment amount; determine, based on the second information set, that the first account comprises remaining funds associated with the second session identifier; and transfer a respective portion of the remaining funds to each of the second plurality of accounts.

The transfer associated with the first session identifier may be made in a first currency and the transfer associated with the second session identifier may be made in a second currency different to the first currency.

In some embodiments, prior to transferring a payment amount, the method comprises operating the processor to: receive a transfer request, the transfer request comprising authentication data; and responsive to determining that the authentication data match predefined criteria, transferring the payment amount. The method may comprise receiving the predefined criteria during a registration process prior to performing the remaining method steps. The transfer request may be received via a user interface and/or received from a device associated with one of the plurality of accounts.

In some embodiments, the first account is associated with a payment card which may, for example, be a virtual payment card.

In some embodiments, operating the processor to transfer a payment amount to a third party account comprises operating the processor to initiate a payment request at a merchant terminal. For example, the merchant terminal may comprise a point of sale terminal.

According to an aspect of the disclosure, there is provided a computer-readable medium comprising non-transitory instructions which, when executed, cause a processor to carry out any of the above-described methods.

According to an aspect of the disclosure, there is provided a network node comprising a processor configured to: receive, in a first account, funds from a plurality of accounts, the received funds being associated with a first session identifier; store a first information set in association with the first session identifier, the first information set comprising details of the funds received; transfer, from the first account, a payment amount to a third party account, the transfer being associated with the first session identifier; update the first information set in accordance with the transferred payment amount; determine, based on the first information set, that the first account comprises remaining funds associated with the first session identifier; and transfer a respective portion of the remaining funds to each of the plurality of accounts.

In some embodiments, the processor is configured such that prior to receiving funds from a plurality of accounts, the processor is operated to: transmit an invite to a respective device associated with each of the plurality of accounts, the invite comprising an indication of the first session identifier. The invite may further comprise an indication of an amount of funds to be transferred to the first account.

In some embodiments, the first information set comprises data indicative of a respective amount received from each of the plurality of accounts and the processor is configured to determine a portion of the remaining funds to transfer to each of the plurality of accounts in accordance with the amount received from the respective account.

In some embodiments, the processor is further configured to: receive, in the first account, funds from a second plurality of accounts, the received funds being associated with a second session identifier; store a second information set in association with the second session identifier, the second information set comprising details of the funds received from the second plurality of accounts; transfer, from the first account, a payment amount to a third party account, the transfer being associated with the second session identifier; update the second information set in accordance with the transferred payment amount; determine, based on the second information set, that the first account comprises remaining funds associated with the second session identifier; and transfer a respective portion of the remaining funds to each of the second plurality of accounts.

The processor may be configured to make the transfer associated with the first session identifier in a first currency and to make the transfer associated with the second session identifier in a second currency different to the first currency.

In some embodiments, the processor is configured such that prior to transferring a payment amount, the processor is operated to: receive a transfer request, the transfer request comprising authentication data; and responsive to determining that the authentication data matches a predefined criteria, transfer the payment amount. The processor may be configured to receive the predefined criteria during a registration process prior to performing the remaining method steps. The processor may be configured to receive the transfer request via a user interface, for example, from a device associated with one of the plurality of accounts.

The first account may be associated with a payment card which may, for example, be a virtual payment card.

In some embodiments, the processor is configured such that transferring a payment amount to a third party account comprises initiating a payment request at a merchant terminal. For example, the merchant terminal may comprise a point of sale terminal.

According to an aspect of the disclosure, there is provided a system for processing a transaction, the system comprising: a network node as described herein; and at least two user devices, each of the at least two user devices being associated with a respective account, wherein the network node and the at least two user devices are configured to communicate over a network.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a system according to an embodiment of the disclosure.

FIG. 2 is a flow diagram depicting an exemplary method of registering a group of users in accordance with an embodiment of the disclosure.

FIG. 3 is a flow diagram depicting an exemplary method of initiating a transaction in accordance with an embodiment of the disclosure.

FIG. 4 is a flow diagram depicting an exemplary method of facilitating a transaction in accordance with an embodiment of the disclosure.

FIG. 5 is a flow diagram depicting a method according to an exemplary embodiment of the disclosure.

### DETAILED DESCRIPTION

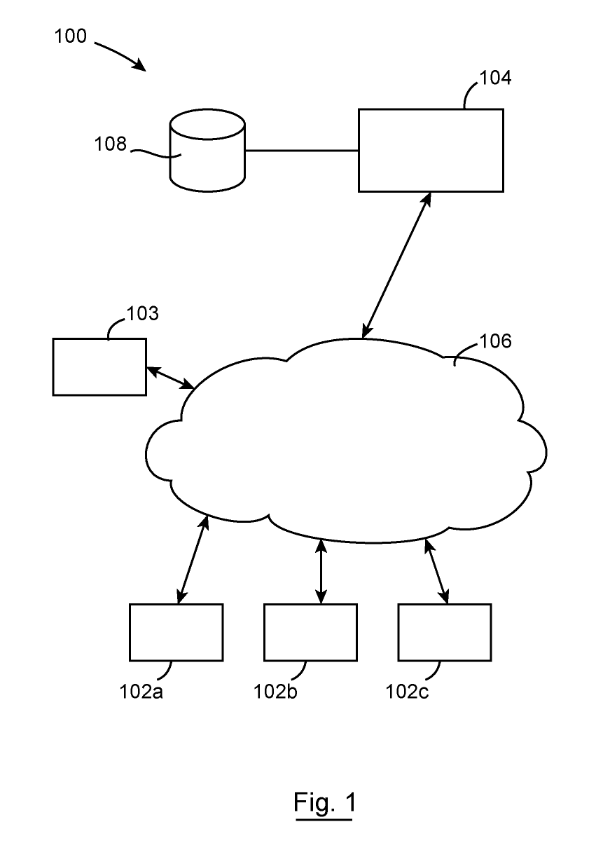

Referring to the drawings and, in particular to FIG. 1, an exemplary system 100 for facilitating a transaction is described.

The system 100 comprises a network node 104 and a plurality of user devices 102a, 102b, 102c capable of, or adapted to, transmit and receive communications over a network 106. It will be appreciated that each of the user devices 102a-c itself comprises a network node and is differentiated from the network node 104 in the following for ease of explanation only.

One or more of the user devices 102a-c may comprise a portable computing device (e.g. a laptop computer, a smartphone, a tablet computer, etc.); a desktop computer; or any other suitable device. In an exemplary embodiment, one or more of the user devices 102a-c is running (or ‘executing’) a software application or ‘app’ which, when executed by a processor of the user device 102a-c, causes the processor to perform the process steps described below.

The network node 104 may comprise, or be comprised within, any suitable device. For example, the network node 104 may comprise, or be comprised within, a remote server. Additionally or alternatively, the network node 104 may be comprised within a base station. In what follows, the network node 104 will be referred to as a single node within the system 100. However, it will be appreciated that the network node may comprise multiple individual nodes at which the request is processed and/or re-transmitted. In an exemplary embodiment, the network node 104 is a server operating in association with a software application or ‘app’ that is running (or being executed) on one or more of the user devices 102a-c.

The network node 104 may be configured to communicate with one or more respective databases 108 via a wired and/or a wireless connection. For example, the network node 104 may write data to the one or more databases 108. Additionally or alternatively, the network node 104 may retrieve data stored in, or accessible to, the database 108.

The network node 104 may be an ‘acquirer network node’ that is associated with (linked to, operated on behalf of, comprised within a system of, etc.) a financial institution that processes (or facilitates) card payments made to a merchant, or provides any other financial services. Additionally or alternatively, the network node 104 may be one or more of a network node associated with (linked to, operated on behalf of, comprised within a system of, etc.) a payment provider (or card issuer); and/or a card payment network node associated with a third party operating as, or in association with, a payment provider.

In what follows, the method steps are described as being performed by the network node 104. However, it will be appreciated that these steps may be performed by other elements of the system 100; or by one or more processors comprised within, or operated by, the network node 104 and/or other elements of the system 100.

The user devices 102a-c and the network node 104 may communicate using any suitable means. For example, the user devices 102a-c and the network node 104 may communicate using one or more of Bluetooth™; Near-Field Communication (NFC); Infra-Red (IR) Communication; and Magnetic Induction.

The system 100 may comprise a merchant terminal 103 capable of, or adapted to, transmit a request to a network node 104 over a network 106. In this respect, it will be appreciated that the merchant terminal 103 itself comprises a network node and is differentiated from the network node 104 in the following for ease of explanation only.

The merchant terminal 103 may comprise, or be comprised within, a physical terminal. For example, the merchant terminal 103 may comprise one or more of: a portable computing device (e.g. a laptop computer, a smartphone, a tablet computer etc.); a desktop computer; a Point Of Sale (POS) or merchant terminal, for example, a terminal located at a physical point of sale such as a shop or restaurant. Alternatively, the merchant terminal 103 may be a virtual terminal associated with a virtual Point Of Sale, e.g. a POS at which online purchases or payments. In some embodiments, the merchant terminal 103 may be an application running on a device such as a portable telephone or computer (e.g. a ‘smartphone’ or tablet computer).

The network 106 may comprise any network across which communications can be transmitted and received. For example, the network 106 may comprise a wired and/or wireless network. The network 106 may, for example, comprise one or more of: the internet; a local area network; a radio network such as a mobile or cellular network; a mobile data network or any other suitable type of network. In one embodiment the user device 102 communicates over the Internet with a network node 104 operating on ‘a cloud’.

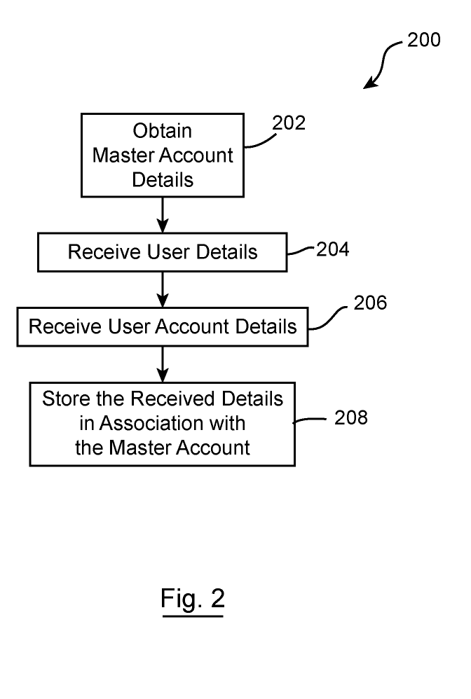

FIG. 2 depicts an exemplary method 200 of registering a group of users to use the system 100 in accordance with an embodiment of the disclosure. It will be appreciated that in embodiments of the disclosure, some steps of the registration process may be combined and/or omitted. Similarly, individual steps of the registration process may be performed at different stages. For example, a user may provide a subset of the information when first registering to use the system 100. The user may then provide additional information during subsequent use of the system 100, e.g. when sending an invite to one or more devices 102a-c and/or when responding to an invite received from another device 102a-c.

At block 202, the network node 104 obtains details pertaining to a master account. The details may comprise any information pertaining to an account into which funds (money) can be transferred and from which payments can be made. For example, the details may comprise an indication of any one or more of an account number; a number of a payment card associated with the account, which may be referred to as a Personal Account Number (PAN); a provider or issuer associated with the account; and any other relevant details. The information received by the network node 104 may comprise the details of the master account. Additionally or alternatively, the network node 104 may generate or retrieve the master account details based on the information provided.

In some embodiments, a payment card is available for purchase in a retail outlet and, a POS 103 transmits an identifier of the payment card to the network node 104 when processing the sale of the payment card. For example, a user may purchase a payment card at a retail outlet. When processing the sale, the POS terminal 103 may then transmit an identifier printed on the card (e.g. a barcode and/or PAN printed on the card) to the network node 104. Responsive to receiving the payment card identifier, the network node 104 may then generate and/or retrieve the master account details.

Additionally or alternatively, at block 202, the network node 104 may receive an indication from a user device 102a-c that a user wishes to create (set-up, initialize, etc.) a master account. For example, a user wishing to register to use the system 100 may indicate via a user interface such as a website and/or an interface of a software application or ‘app’ that he wishes to create an account for use with the system 100. Responsive to receiving this indication from the user, the network node 104 may create an account and associated master account details. Additionally or alternatively, the network node 104 may transmit a request to a further network node and receive the master account details once the account has been created.

At block 204, the network node 104 receives user details pertaining to a user wishing to use the system 100. The details received at block 204 may pertain to a user who initiated the registration process at block 202, e.g. the user who purchased the payment card and/or provided an indication of his/her desire to use the system 100. Additionally or alternatively, the details received at block 204 may pertain to one or more further users wishing to use the system 100 and, in particular, wishing to use the account to which the master account details pertain. In some embodiments the details received at block 204 may be received in response to an invite issued to a user to use the system 100.

The user details may comprise any suitable details pertaining to the user such as any one or more of: name, address, date of birth, contact number, email address, username, etc. In some embodiments, in order to increase security and/or meet regulatory requirements, the received details include copies of formal identification documents such as a passport or driver's license.

The details received at block 204 may additionally or alternatively comprise authentication details which may be required for a user to use or ‘log-in’ to the system 100. For example, the details may comprise one or more of: a username; a password; a security question; or any other suitable authentication details.

The user may input the user details via any suitable interface. For example, the registration interface may be provided online via a provider website (not shown), via a telephone service, in person, etc. In some embodiments, a processor of the device 102a-c executes a software application or ‘app’ associated with the network node 104 and the user inputs the registration information via a user interface of the app. The user details may be input via the same registration interface as the master account details and/or an indication that the user wishes to use the system at block 202. Alternatively, the user details may be input via a different registration interface than the details provided at block 202.

At block 206, the network node 104 receives information pertaining to an account associated with the user. The information received at step 206 comprises information required to authorize a payment from the user account and/or to lodge payments to the user account. In some embodiments, the account details provided at block 206 comprises information pertaining to a debit or credit card registered to (owned by or associated with) the user. In particular, the received details may comprise a card number or other identifier associated with the user's account. The card number or identifier may be referred to as a Primary Account Number (PAN). The number comprised within the received details may be a number of a physical (regular or actual) credit and/or debit card, e.g. a number printed on a cardholder's card and linked to a cardholder's account.

The number indicated at block 206 may additionally or alternatively be a virtual card number (a dynamic credit card number, a controlled payment number, an alias number, a one-time use credit card number, a substitute credit card number, a rechargeable credit card number, etc.). A virtual card number is generated by a card issuer and is linked to at least one physical card number and account. The virtual card number may, for example, be generated via a Web application or a specialized client program provided by, or associated with, an issuer of the physical card number to which the virtual card number is linked.

Additionally, the details received at block 206 may comprise information indicative of one or more of: a billing address; a payment provider associated with the card; the expiry date of the card; the issue date of the card; the credit card verification (CCV) number of the card; and a response to a security question previously set by the user. In some embodiments, the received account details comprise information pertaining to a virtual account, e.g. an account relating to a virtual currency and/or an online ‘wallet’.

In this manner, a user account, e.g. a current savings or credit card account, is associated with the master account. As will be described in more detail below, the user account may then be used to ‘load’ i.e. transfer money into, or make payments to, the master account.

At block 208, the network node 104 creates a master account profile comprising parameters defined in accordance with the information received at steps 202 to 206. The network node 104 may store the created profile in the database 108 and or any other suitable storage means. As will be discussed in more detail below, the network node 104 uses the master account profile to facilitate transactions between the users registered in the profile and the master account and between the master account and third parties.

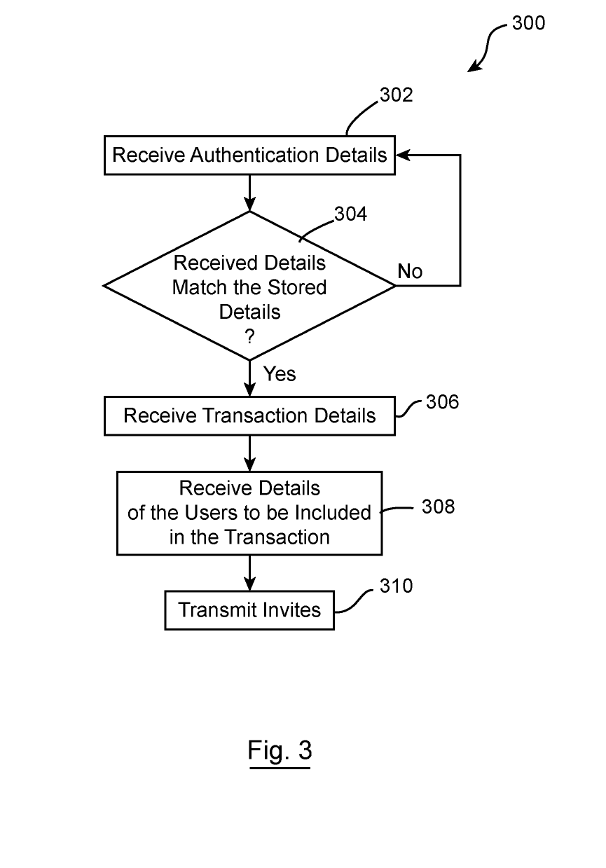

FIG. 3 is a flow diagram depicting an exemplary method 300 of initiating a transaction in accordance with an embodiment of the disclosure.

At block 302, the network node 104 receives authentication details from a user device 102a-c indicating that a user wishes to initiate a transaction. The authentication details comprise information pertaining to a registered user, e.g. a user who previously completed the registration process described in relation to FIG. 2, wishing to initiate a transaction between a plurality of users. In an exemplary embodiment, the authentication details comprise a username and/or password stored during the registration process. For example, a user wishing to initiate or facilitate a group transaction may ‘log-on’ to a website to do so. Additionally or alternatively, the user may initiate the transaction via a software application or ‘app’ associated with the network node 104.

At block 304, the network node 104 determines whether the received authentication details match authentication details stored in association with the indicated user and/or master account. For example, the network node 104 may compare the received authentication details to details received at step 204 of the registration process and/or any other information stored in the master account profile.

Responsive to determining that the received details do not match the stored details, processing returns to block 302. In some embodiments, after a predefined number of incorrect authentication details, the master account associated with the details may be temporarily suspended (deactivated, locked, or frozen).

Responsive to determining that the received details match the stored details, at block 306, the network node 104 receives information pertaining to a transaction to be initiated. This information may comprise any suitable details of the transaction. In an exemplary embodiment, the information comprises details of any one or more of a total payment amount associated with the transaction; a payment recipient; a description of the transaction; and any other information indicated by the user.

For example, a user initiating payment of a holiday on behalf of a group of friends may provide details of a total cost of the holiday, the holiday provider to be paid, and a brief description of the holiday and what is included in the price, e.g. that the price is all-inclusive, that it was decided to go with the hotel closest to the beach, the deadline by which the participants must pay, etc.

At block 308 the network node 104 receives data comprising an indication of one or more users to be included in the transaction. For example, the received data may comprise any one or more of: an email address; a telephone number; a username or user id; and any other suitable information based upon which the network node 104 can identify a user. In some embodiments, the information received at block 308 further comprises an indication of a respective amount to be paid by at least some of the indicated users. In this manner, a user initiating a transaction can select to have different users pay or contribute different amounts for the transaction. For example, some friends in a group may wish to upgrade a hotel room to a suite in which case they will contribute a larger amount to the cost of the holiday. Alternatively, the network node 104 may divide the total amount to be paid equally between the indicated users.

At block 310, based on the information received at the previous step, the network node 104 transmits an invite to a respective user device 102a-c associated with each of the indicated users. In some embodiments, an invite is also sent to the user initiating the transaction. The invite comprises an indication of a session or transaction identifier. The transaction identifier may be any suitable identifier which enables the network node 104 to identify a transaction in relation to which the invites (and responses thereto) pertain. In this manner, the network node 104 can concurrently process multiple transactions associated with a master account.

The network node 104 transmits the invites by any suitable manner. For example, the network node 104 may transmit the invites via one or more of: email; telephone call; SMS; a notification associated with a software application ‘app’ being executed by a user device, etc.

In an exemplary embodiment in which the information received at block 306 comprises an indication of a username of one or more users, at block 308 the network node 104 identifies a user profile associated with the indicated username. For example, the user profile may be stored in database 108 and/or any other storage accessible to the network node 104. Based on the details comprised within the user profile, the network node 104 may identify a means for contacting the user. For example, the network node may identify a preferred means of contacting the user and transmit the invite in accordance with the identified contact means.

Responsive to receiving an invite, two or more of the users make a payment (or transfers funds) to the master account in accordance with the payment details indicated in the received invite. The payment may be affected in any suitable manner. For example, a user may affect the payment by one or more of: making a transfer using electronic banking; making a transfer using telephone banking; and making a payment at a virtual or physical POS associated with the system 100.

In some embodiments, the invitation transmitted to one or more of the users comprises a link (e.g. a button, hyperlink, etc.) the selection of which results in the transfer of the indicated amount of money from an account associated with the user to the master account. For example, the user may provide his/her account details during a registration process (e.g. at block 206 of the registration process 200) and subsequent payments may be made from the user account to the master account without requiring the user to provide the account details again.

Regardless of the manner in which the payment is made, the payment comprises an indication of the transaction identifier so that the transaction to which the payment relates may be identified. In this manner, the network node can determine a transaction to which the received funds pertain.

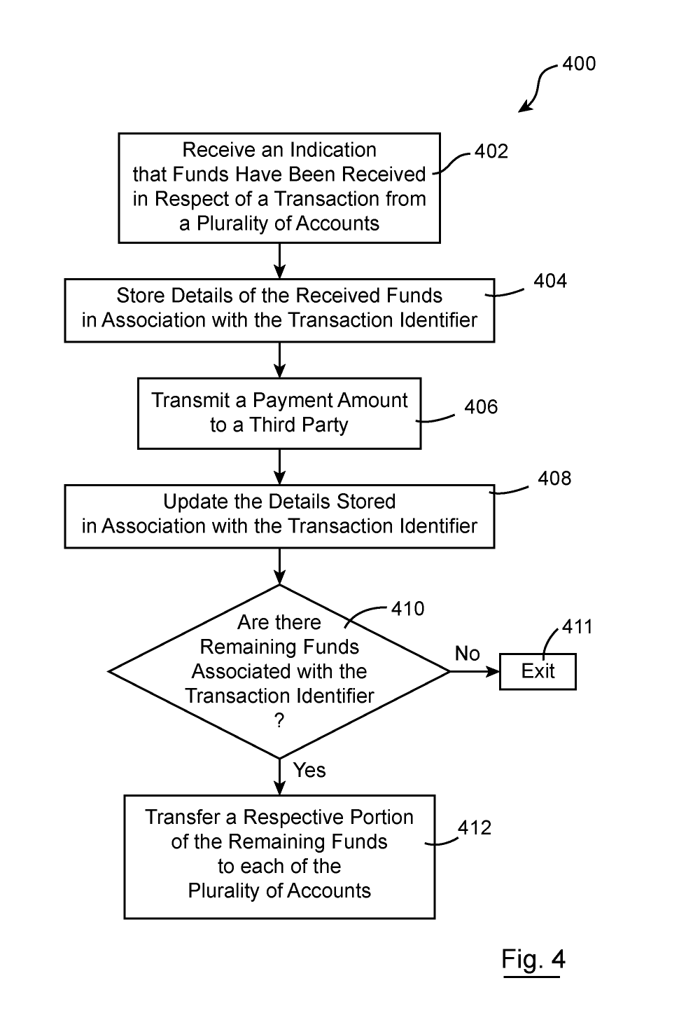

FIG. 4 depicts a method 400 of facilitating a transaction from a master account according to an exemplary embodiment of the disclosure.

At block 402, the network node 104 receives an indication that funds have been transferred from a plurality of accounts to the master account. The indication may comprise any one or more suitable indicators or notification. For example, the network node 104 may receive a notification from a payment provider associated with the master account when funds are received from one or more of the plurality of accounts. The indication received at block 402 comprises an indication of the transaction identifier. The transaction identifier may be the identifier included in the invite transmitted at block 308 and/or the payments received in response to the invites. Additionally or alternatively, the transaction identifier may be a username, and/or any other suitable identifier on the basis of which the network node 104 can determine the transaction in relation to which the funds were received.

At block 404, the network node 104 stores information pertaining to the received funds in association with the transaction identifier. The stored information comprises an indication of the total amount of funds received from payments comprising an indication of the transaction identifier together with an indication of the users from which the funds were received and account details pertaining to each of these users. In some embodiments, the stored information further comprises an indication of an amount received from each of the plurality of users.

At block 406, the network node 104 affects a payment from the master account to a third party. The network node 104 may affect the payment by transmitting a payment request to a payment provider associated with the master account.

The network node 104 may affect the payment automatically in response to determining that the funds required for the transaction have been received. For example, the network node 104 may determine, based on the information pertaining to the received funds, that funds equal to or greater than the total payment amount indicated at block 306 of method 300 have been received and then affect the payment automatically.

Alternatively, the network node 104 may affect the payment in response to an instruction or command from one of the users, e.g. the initiating user. The user may issue the instruction to make the payment by affecting a payment in any other usual manner, e.g. by providing details of the account to the third party; affecting a transfer using electronic or telephone banking etc..

In some embodiments, the user issues an instruction to make the payment by affecting a payment using a payment card or a PAN associated with the master account. Additionally or alternatively, the initiating user or a user indicated (or authorized) by the initiating user may instruct the network node 104 via a user interface of a software application or ‘app’ to affect the payment.

In an example in which a user is making a payment for a group holiday, on determining that sufficient funds have been received (or funds have been received for all the invitees), the initiating user may affect the payment at a POS 103 operated by (or on behalf of) the holiday provider. For example, the initiating user may affect the payment using a payment card associated with the master account. In this case, the POS 103 transmits a payment request to the network node 104.

At block 408, the network node 104 updates the details stored in association with the transaction identifier in accordance with the amount transferred to the third party. At block 410, based on the stored details, the network node 104 determines whether there are remaining funds associated with the transaction identifier.

Responsive to determining that the master account no longer comprises funds relating to the transaction identifier, processing exits at step 411. It will be appreciated that the network node 104 may continue to process other transactions associated with the master account.

If, at block 410, the network node 104 determines that the master account still comprises funds associated with the transaction identifier (i.e. there are funds ‘left-over’ after making the payment to the third party), the network node 104 identifies the contributing users for the transaction, i.e. the users from whom payments were received in association with the transaction identifier. Based on the stored account details pertaining to each of the contributing users, the network node 104 then transfers, at block 412, a respective portion of the remaining funds to these users.

The network node 104 may divide the remaining funds equally between the contributing users. Alternatively, the network node 104 may divide the remaining funds in accordance with a predefined rule, e.g. a rule defined by the initiating user. For example, where some users paid extra for an upgrade, if upgraded rooms were not available the initiating user can indicate that these users only should be refunded.

In embodiments in which the network node 104 stores information of an amount of funds received from each of the plurality of users, the network node 104 may divide the remaining funds in accordance with the amounts received.

As discussed above, the methods 300 and 400 may be performed in association with multiple transactions concurrently. Accordingly, for a given master account, a user can set up a first transaction to which a first group of users contribute and a second transaction to which a second group of users contribute. In some embodiments, the first and second transactions may relate to payments affected in different currencies (one or more of which may be a virtual currency). For example, the first transaction may relate to a payment in pounds sterling whilst the second transaction relates to a payment in euro.

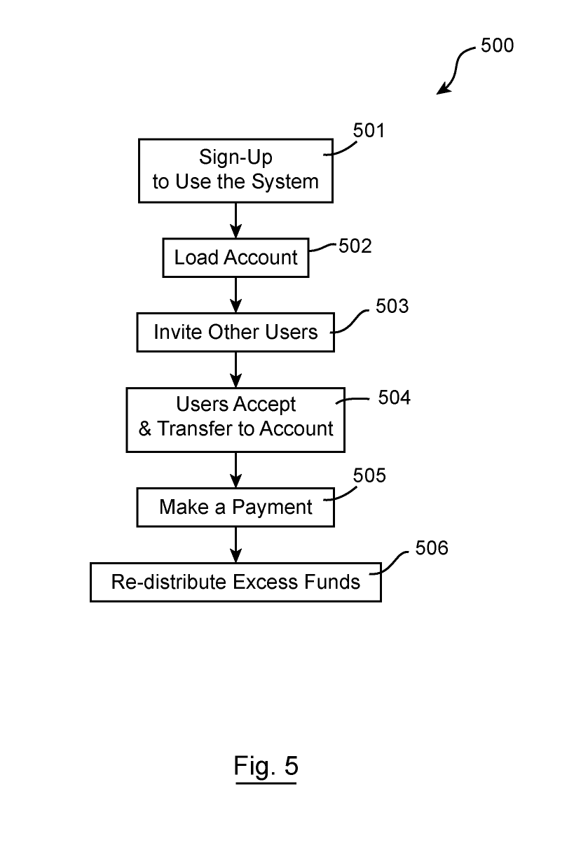

FIG. 5 is a flow diagram depicting a method 500 according to an exemplary embodiment of the disclosure.

At block 501, an initiating user signs up to use the system 100 and provides required identification details. Responsive to receiving the user details, the network node 104 creates a account for the user. The account is associated with a payment card which can be used to affect payments from the account. The payment card may, for example, be associated with a security PIN (Personal Identification Number) which may be required to authorize payments made using the card.

At block 502, the initiating user ‘loads’ the account using a desired payment source. For example, the user may transfer funds from a personal bank account to the account (using e.g. telephone and/or online banking). The user executes a software application on an electronic device and affects the transfer via the software application.

At block 503, the initiating user invites other members to contribute or ‘load’ funds into the account. The invited users are also users who have signed up to use the system 100 and who each have respective payment accounts and payment cards. The initiating user issues the invites to the other members via the software application so that the invited users receive notifications and/or emails indicating that they have been invited to take part in a payment. The invite indicates an amount to be paid by the user to whom the invite is sent together with an indication of the initiating user and any other information provided by the initiating user.

For example, a group of friends who have signed up to use the system may go for a meal together. At the end of the meal, one of the friends (the ‘initiating user’) provides an indication of each of the friends (e.g. a username) together with a respective amount to be paid by that friend to a network node 104 via a software application. The network node 104 then transmits notifications or invites to each of the friends in accordance with the indicated information.

At block 504, the invited users accept the invitation and transfer the indicated amounts of money to the initiating user's account. In the exemplary scenario in which the invites are transmitted in the form of application notifications, the users may accept the invites by selecting a link or button included in the notification. In this manner, each user can easily and efficiently transfer money directly from his/her respective account to the account of the initiating user. Affecting the transfer may require the user to provide authentication/security details such as the details required to access or ‘log-on’ to use the system 100.

At block 505, the initiating user makes a payment from his/her account on behalf of the contributing users. For example, the initiating user may pay the restaurant bill on behalf of the group of friends.

At block 506, the initiating user refunds any excess funds to the contributing users. The refund can be affected by the user identifying the users to receive some of the excess funds and optionally indicating an amount to be refunded to each user. For example, in the above-described restaurant scenario, excess funds may be refunded to members of the group of friends who did not have a desert, etc. In this manner, payments can be ‘divided’ or ‘split’ between a plurality of users easily and efficiently and any excess funds can be easily re-distributed among the group.

The present disclosure is not limited to the embodiment(s) described herein but can be amended or modified without departing from the scope of the present disclosure. Additionally, it will be appreciated that in embodiments of the disclosure some of the above-described steps may be omitted and/or performed in an order other than that described.

In addition, it should be appreciated that the functions and/or steps (or operations) described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A computer-implemented method of processing a transaction, the method being performed at a network node and comprising:
receiving, by a processor, in a first account, funds from a plurality of accounts, the received funds being associated with a first session identifier;
storing, by the processor, a first information set in association with the first session identifier, the first information set comprising details of the funds received;
transferring, by the processor, from the first account, a payment amount to a third party account, the transfer being associated with the first session identifier;
updating, by the processor, the first information set in accordance with the transferred payment amount;
determining, by the processor, based on the first information set, that the first account comprises remaining funds associated with the first session identifier; and
transferring, by the processor, a respective portion of the remaining funds to each of the plurality of accounts.

2. The method of claim 1, further comprising, prior to receiving funds from a plurality of accounts:
transmitting, by the processor, an invite to a respective device associated with each of the plurality of accounts, the invite comprising an indication of the first session identifier and/or an indication of an amount of funds to be transferred to the first account.

3. (canceled)

4. The method of claim 1, wherein the first information set comprises data indicative of a respective amount received from each of the plurality of accounts; and
further comprising determining, by the processor, a portion of the remaining funds to transfer to each of the plurality of accounts in accordance with the amount received from the respective account.

5. The method of claim 1, further comprising:
receiving, by the processor, in the first account, funds from a second plurality of accounts, the received funds being associated with a second session identifier;
storing, by the processor, a second information set in association with the second session identifier, the second information set comprising details of the funds received from the second plurality of accounts;
transferring, by the processor, from the first account, a payment amount to a third party account, the transfer being associated with the second session identifier;
updating, by the processor, the second information set in accordance with the transferred payment amount;
determining, by the processor, based on the second information set, that the first account comprises remaining funds associated with the second session identifier; and
transferring, by the processor, a respective portion of the remaining funds to each of the second plurality of accounts.

6. The method of claim 5, wherein the transfer associated with the first session identifier is made in a first currency and the transfer associated with the second session identifier is made in a second currency different to the first currency.

7. The method of claim 1, further comprising, prior to transferring a payment amount:
receiving, by the processor, a transfer request, the transfer request comprising authentication data; and
responsive to determining, by the processor, that the authentication data matches a predefined criteria, transferring the payment amount.

8. The method of claim 7, further comprising receiving, by the processor, the predefined criteria during a registration process prior to performing the remaining method operations.

9. The method of claim 7, wherein the transfer request is received via a user interface and/or from a device associated with one or the plurality of accounts.

10.-12. (canceled)

13. The method of claim 1, wherein transferring a payment amount to a third party account comprises initiating a payment request at a merchant terminal.

14. (canceled)

15. (canceled)

16. A network node comprising a processor configured to:
receive, in a first account, funds from a plurality of accounts, the received funds being associated with a first session identifier;
store a first information set in association with the first session identifier, the first information set comprising details of the funds received;
transfer, from the first account, a payment amount to a third party account, the transfer being associated with the first session identifier;
update the first information set in accordance with the transferred payment amount;
determine, based on the first information set, that the first account comprises remaining funds associated with the first session identifier; and
transfer a respective portion of the remaining funds to each of the plurality of accounts.

17. The network node of claim 16 wherein the processor is configured such that prior to receiving funds from a plurality of accounts, the processor is operated to:
transmit an invite to a respective device associated with each of the plurality of accounts, the invite comprising an indication of the first session identifier and/or an indication of an amount of funds to be transferred to the first account.

18. (canceled)

19. The network node of claim 16, wherein the first information set comprises data indicative of a respective amount received from each of the plurality of accounts and the processor is configured to determine a portion of the remaining funds to transfer to each of the plurality of accounts in accordance with the amount received from the respective account.

20. The network node of claim 16, wherein the processor is further configured to:
receive, in the first account, funds from a second plurality of accounts, the received funds being associated with a second session identifier;
store a second information set in association with the second session identifier, the second information set comprising details of the funds received from the second plurality of accounts;
transfer, from the first account, a payment amount to a third party account, the transfer being associated with the second session identifier;
update the second information set in accordance with the transferred payment amount;
determine, based on the second information set, that the first account comprises remaining funds associated with the second session identifier; and
transfer a respective portion of the remaining funds to each of the second plurality of accounts.

21. The network node of claim 20, wherein the processor is configured to make the transfer associated with the first session identifier in a first currency and to make the transfer associated with the second session identifier in a second currency different to the first currency.

22. The network node of claim 16, wherein the processor is configured such that prior to transferring a payment amount, the processor is operated to:
receive a transfer request, the transfer request comprising authentication data; and
responsive to determining that the authentication data matches a predefined criteria, transfer the payment amount.

23. The network node of claim 22, wherein the processor is configured to receive the predefined criteria during a registration process prior to performing the remaining method operations.

24. The network node of claim 22, wherein the processor is configured to receive the transfer request via a user interface and/or from a device associated with one of the plurality of accounts.

25. (canceled)

26. The network node of claim 16, wherein the first account is associated with a virtual payment card.

27. (canceled)

28. The network node of claim 16, wherein the processor is configured such that transferring a payment amount to a third party account comprises initiating a payment request at a merchant terminal.

29. (canceled)

30. A system for processing a transaction, the system comprising:
a network node comprising at least one processor configured to:
receive, in a first account, funds from a plurality of accounts, the received funds being associated with a first session identifier;
store a first information set in association with the first session identifier, the first information set comprising details of the funds received;
transfer, from the first account, a payment amount to a third party account, the transfer being associated with the first session identifier;
update the first information set in accordance with the transferred payment amount;
determine, based on the first information set, that the first account comprises remaining funds associated with the first session identifier; and
transfer a respective portion of the remaining funds to each of the plurality of accounts; and
at least two user devices, each of the at least two user devices being associated with a respective account, wherein the network node and the at least two user devices are configured to communicate over a network.
